(19) United States
(12) Patent Application Publication
(10) Pub. No.: US 2012/0171780 A1
(43) Pub. Date: Jul. 5, 2012

(54) FLUORESCENT POLYMERS AND METHODS FOR SOLID-PHASE EXTRACTION

(75) Inventors: Raymond Douglas Coker, Bromley (GB); Sergey Piletsky, Cranfield (GB); Olena Piletska, Cranfield (GB)

(73) Assignee: Toximet Limited, Sittingbourne (GB)

(21) Appl. No.: 13/382,646

(22) PCT Filed: Jun. 30, 2010
(86) PCT No.: PCT/GB2010/051076

§ 371 Date: Mar. 1, 2012

(30) Foreign Application Priority Data
Jul. 7, 2009 (GB) 0911743.3

(51) Int. Cl. G01N 21/64

(52) U.S. Cl. 436/501; 422/69

(57) ABSTRACT

The apparatus of the present invention comprises a fluorescent polymer contained within a solid-phase extraction (SPE) carrier. The fluorescent polymer is capable of adsorbing an analyte by means of functional monomers. In use of the apparatus, a sample, such as a foodstuff sample, is applied to the fluorescent polymer. If the sample comprises the analyte, adsorption of the analyte onto the fluorescent polymer causes quenching of the fluorescence of the fluorescent polymer. Fluorescence quenching can be detected using a fluorometer or transillumination system. The method can be used to determine whether mycotoxins are present in foodstuff samples.

### FIELD OF THE INVENTION

The present invention relates to fluorescent polymers for solid-phase extraction (SPE) and to the detection of analytes using fluorescence quenching.

### BACKGROUND OF THE INVENTION

A wide variety of human foods and animal feeds, including edible nuts, oilseeds, cereal grains, forages and products derived from them are susceptible to contamination by mycotoxins, which are toxic metabolic by-products of fungi. Contamination can occur on food and feed crops before and/or after harvest. Among the most significant mycotoxin contaminants are the aflatoxins and ochratoxins. Direct determination of mycotoxin level is an important aspect of quality control in foods and feeds.

Such measurements have conventionally been carried out using high performance liquid chromatography (HPLC). However in cases where HPLC equipment is not available or appropriate, determination by thin layer chromatography (TLC) is also possible. Commercial scanners are available for mycotoxin determination of samples that have been subject to TLC separation. The scanners use mercury lamps with an emission wavelength of 366 nm as a light source to stimulate fluorescence. Fluorescence is then detected and quantified by photo-multipliers.

In some thin layer chromatography matrices, the adsorbent layer contains an inorganic phosphorescent or organic fluorescent indicator. In these systems, detection of analytes relies on the quenching of phosphorescence or fluorescence by the sample components. Analytes capable of quenching background fluorescence include chemicals containing aromatic moieties—for example large macrolides, such as antibiotics and other natural products.

Before a solution obtained by extraction from a foodstuff sample is subjected to quantitative measurement, the solution may be subjected to a ‘clean-up’ procedure. Clean-up generally involves using solid-phase extraction to remove compounds that may interfere with the mycotoxin evaluation.

Qualitative detection of mycotoxins can be carried out using small chromatographic columns (so-called Thinicolumns) in which the mycotoxins are immobilised as a layer within a mineral adsorbent in the minicolumns. The minicolumns are viewed under ultraviolet light to cause the immobilised mycotoxin to fluoresce. Various minicolumn methods have been adopted as official tests of the AOAC (Association of Official Analytical Communities) International to check for the presence of mycotoxins.

For the quantitative assay of mycotoxins, WO 2006/123189 describes fluorometric apparatus for assessing mycotoxin samples immobilised in layers in minicolumns. The apparatus can also be used to assess mycotoxins immobilised in molecularly imprinted polymers and non-molecularly imprinted (blank) polymers provided as adsorbents in solid phase extraction (SPE) cartridges.

Such a system comprising an SPE cartridge and fluorometric apparatus can be used to detect analytes other than mycotoxins. Alternative applications within the food sector include the measurement of pesticide and veterinary residues, algal toxins, illicit dyes (e.g. Sudan I), and indicators of food quality. Outside the food sector, areas where the cartridges and apparatus can potentially be used include the control of environmental pollutants, drug abuse and counterfeit drugs. Applications could also be found in the forensic and healthcare (point of care) sectors.

In a conventional SPE cartridge, a non-fluorescent adsorbent is used to adsorb an analyte. Binding can then be detected by observing the fluorescence of any bound compounds. The present invention is based on use of a fluorescent polymer. Binding of an analyte is detected by observing any quenching of the fluorescence of the polymer.

### SUMMARY OF THE INVENTION

In one aspect, the present invention provides apparatus for detecting an analyte by fluorescence quenching, the apparatus comprising an SPE carrier loaded with a polymer, the polymer having functional monomers for binding the analyte, wherein the polymer is fluorescent. In use, analyte binding quenches fluorescence of the polymer.

In one embodiment, the fluorescent polymer comprises an inorganic fluorescent indicator, such as Fluorescent Indicator Green 254 nm.

In another embodiment, the fluorescent polymer is produced using a polymerisable UV-adsorbent or fluorescent monomer, co-monomer or template, such as acenaphthylene.

Suitably, the SPE carrier is a cartridge, tube, cuvette, rod or flat surface.

To adsorb a wide variety of analytes, a typical base polymer of the present invention is prepared using itaconic acid or diethylaminoethyl methacrylate (DEAEM) as functional monomers. In the preferred polymer, ethylene glycol dimethacrylate (EGDMA) is present as a cross-linker and 1,1′-azobis(cyclohexanecarbonitrile) as initiator.

The polymer is preferably made porous. A suitable porogen is N,N-dimethylformamide (DMF), with 1.1′-azobis(cyclohexanecarbonitrile) as initiator.

The fluorescent polymers used in the present invention are particularly suitable for quantitative analysis of tylosin, chloramphenicol, Sudan II, Sudan III, ATP, acenaphthylene and N,N′-diethyldithiocarbamic acid benzyl ester (DCABE) by fluorescence quenching.

The preferred apparatus also comprises fluorometric apparatus or transillumination apparatus.

In another aspect, the present invention provides a method of detecting the presence of an analyte in a sample comprising the steps of: providing an SPE carrier loaded with a fluorescent polymer, the polymer having functional monomers for binding the analyte; applying the analyte to the fluorescent polymer; and detecting fluorescence quenching resulting from adsorption of the analyte onto the polymer.

To achieve this, an SPE carrier, such as a cartridge, tube, cuvette, rod or flat surface is loaded with the fluorescent polymer in lieu of a conventional SPE adsorbent polymer.

The presence of an analyte in a sample is detected by measuring the reduction in polymer fluorescence using, for example, the fluorometric apparatus described in WO 2006/123189. Preferably, the analyte has high adsorption in the short UV range and minimal natural fluorescence.

In one embodiment, the fluorescent polymer comprises an inorganic fluorescent indicator, such as Fluorescent Indicator Green 254 nm. In another embodiment, the polymer is produced using a polymerisable UV-adsorbent or fluorescent monomer, co-monomer or template, such as acenaphthylene.

Ideally, the fluorescent polymer comprises itaconic acid or DEAEM as functional monomers and optionally EGDMA as a cross-linker and 1,1′-azobis(cyclohexanecarbonitrile) as an initiator.

A further aspect of the present invention provides for the use of the fluorescent polymers described above as SPE adsorbents. A fluorescent polymer for use as an SPE adsorbent forms another aspect of the present invention.

The above and other aspects of the present invention will now be described, by way of example only, in further detail with reference to the following Examples and the accompanying drawings.

### BRIEF DESCRIPTION OF THE DRAWINGS

FIG. 1 is a plot illustrating fluorescence quenching of Polymer 1 by tylosin;

FIG. 2 is a plot illustrating fluorescence quenching of Polymer 1 by morphine hydrochloride;

FIG. 3 is a plot illustrating fluorescence quenching of Polymer 1 by acenaphthylene;

FIG. 4 is an image illustrating acenaphthylene adsorption on Polymer 1 made using a transilluminator;

FIG. 5 is a plot illustrating fluorescence quenching of Polymer 2 by ATP;

FIG. 6 is a plot illustrating fluorescence quenching of Polymer 3 by tylosin;

FIG. 7 is an image illustrating tylosin adsorption on Polymer 3 made using a transilluminator;

FIG. 8 is a plot illustrating fluorescence quenching of Polymer 3 by chloramphenicol;

FIG. 9 is a direct and inverted image illustrating chloramphenicol adsorption on Polymer 3 made using a transilluminator;

FIG. 10 is a plot illustrating fluorescence quenching of Polymer 3 by Sudan II;

FIG. 11 is a direct and inverted image illustrating Sudan II adsorption on Polymer 3 made using a transilluminator;

FIG. 12 is a plot illustrating fluorescence quenching of Polymer 3 by Sudan III;

FIG. 13 is a direct and inverted image illustrating Sudan III adsorption on Polymer 3 made using a transilluminator in direct and inverted image;

FIG. 14 is a plot illustrating fluorescence quenching of Polymer 4 by ATP;

FIG. 15 is a plot illustrating fluorescence quenching of Polymer 4 by DCABE; and

FIG. 16 is a direct and inverted image illustrating DCABE adsorption on Polymer 4 made using a transilluminator.

### DETAILED DESCRIPTION OF THE INVENTION

In the preferred embodiment of the present invention, a fluorescent polymer loaded onto an SPE carrier selectively binds an analyte by means of functional monomers. Appropriate functional monomers for binding the analyte in question can be determined using molecular modelling. The fluorescent polymer is rendered fluorescent either by trapping a fluorescent compound within the polymer matrix or by using a polymerisable fluorescent or UV-adsorbent monomer or co-monomer as a starting material.

To increase the surface area of the fluorescent polymer available for binding the analyte, the polymer is made porous. A porous polymer is prepared by polymerising a functional monomer and a cross-linker in the presence of a porogen. A porogen is a material that is dispersible in the monomers (and remains dispersed in the polymers after reaction of the monomers) and that can be removed after the polymer is formed to generate pores within the polymer.

A suitable porogen is inert in the polymerisation reaction. Porogens may be solids, liquids or gases. Solids or liquids can be removed by decomposition or by ‘dissolving-out’ with a suitable solvent. In the preferred embodiment of the present invention, a liquid porogen is used that can be finely dispersed in the polymerisation mixture by stirring, and can be removed by washing the polymer with a suitable solvent.

When the functional monomers are cross-linked with EGDMA, then a particularly suitable porogen is N,N-dimethylformamide (DMF). Acetonitrile, methanol, toluene, ethanol, glycerol, water or other solvents or mixtures thereof used for radical polymerisation may also be used.

Suitable analytes for use with the preferred embodiment of an SPE carrier loaded with a fluorescent polymer have high absorption in the short UV range. It is advantageous if the analyte has little or no natural fluorescence. However, analytes with fluorescence emission in a spectral region that does not overlap with the fluorescence of the polymer are also advantageous. As illustrated in the Examples, preferred analytes for fluorescence quenching include tylosin, chloramphenicol, Sudan II, Sudan III, ATP, acenaphthylene and DCABE. Other examples include pharmaceuticals, proteins and toxins.

Compounds immobilised on a fluorescent polymer reduce the fluorescent properties of the polymer. Such a reduction in fluorescence is likely to be associated with a change in polarity resulting from binding. However, a reduction in fluorescence could result from absorption of excitation or emission radiation by the bound analyte.

In the preferred embodiment, any fluorescence quenching is detected by means of fluorometric apparatus, a Toximet-T instrument or by means of a transillumination system.

### Example 1

### Polymer Preparation

Fluorescent polymers were prepared using the amounts of monomers set out in the table below. Polymers 1 and 2 comprise negative and positive functionalities respectively, as well as a fluorescent indicator excitable at 254 nm. Polymers 3 and 4 comprise negative and positive functionalities respectively, as well as a polymerisable UV-adsorbent template.

| Polymers (g) | 1 | 2 | 3 | 4 |
|---|---|---|---|---|
| Itaconic acid | 2.5 | — | 2 | — |
| DEAEM | — | 5 | — | 2 |
| EGDMA | 20 | 20 | 8 | 8 |
| DMF | 25 | 25 | 10 | 10 |
| 1,1′-azobis(cyclohexanecarbonitrile) | 0.25 | 0.25 | 0.1 | 0.1 |
| Fluorescent Indicator Green 254 nm | 2.5 | 2.5 | — | — |
| Acenaphthylene | | | 0.05 | 0.05 |

The monomers were purged with nitrogen and polymerised in an oil bath at 80° C. for 14 h. The polymers were ground and sieved using an Ultracentrifuge Mill and Shaker (Retsch, Germany). For Polymers 1 and 2, fractions with particle size 38-106 μm were collected. For Polymers 3 and 4, fractions 20-106 μm were collected. The polymers were washed extensively with methanol.

### Example 2

### Polymer 1: Tylosin as Analyte

Tylosin is a large cyclic molecule with high absorbance in the short UV range. A polymer specific for adsorbance of tylosin has been produced and tested—as reported in “Piletsky S. A., Piletska E. V., Karim K., Foster G., Legge C. H., Turner A. P. F. (2003) Custom synthesis of molecular imprinted polymers for biotechnological application. Preparation of a polymer specific for tylosin. Anal. Chem. Acta, 504, 123-130”. The polymer contains itaconic acid as a functional monomer and has good selectivity and affinity towards tylosin.

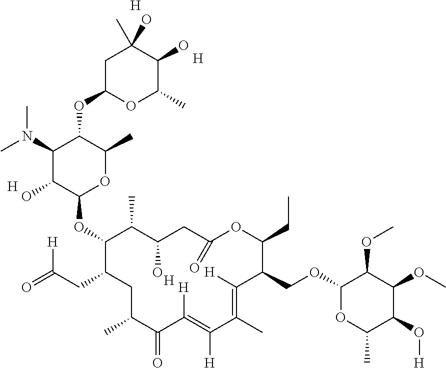

SPE tubes were packed with 75 mg of Polymer 1 (itaconic acid). 1 ml of tylosin tartrate in 5% methanol (3 mg/ml) was filtered through the cartridge. Changes in optical properties of the polymer before and after binding of tylosin were measured using a Toximet-T instrument equipped with a light emitting diode (LED) capable of producing light at λ=260 nm and a cut-off filter with λ=360 nm.

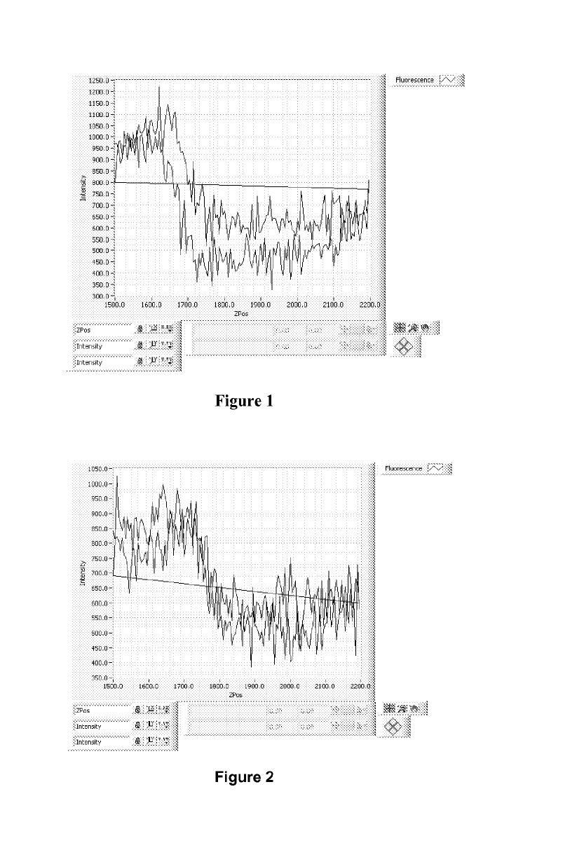

It was found that adsorption of tylosin quenched the fluorescence of Polymer 1 by about 25% (FIG. 1).

### Example 3

### Polymer 1: Morphine as Analyte

Morphine is representative of a group of opiates. It is a large cyclic molecule which is positively charged and it can be adsorbed using a polymer containing itaconic acid as a functional monomer.

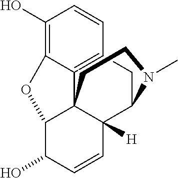

A solution of morphine hydrochloride (4 mg/ml in water) was loaded onto Polymer 1, as described in Example 2. Changes in the optical properties of the polymer were measured using a Toximet-T instrument.

Binding morphine led to quenching of fluorescence by approximately 16% (FIG. 2).

### Example 4

### Polymer 1: Acenaphthylene as Analyte

SPE tubes were packed with 75 mg of Polymer 1 (itaconic acid). 1 ml of acenaphthylene in methanol (3 mg/ml) was filtered through the cartridge.

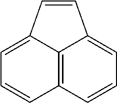

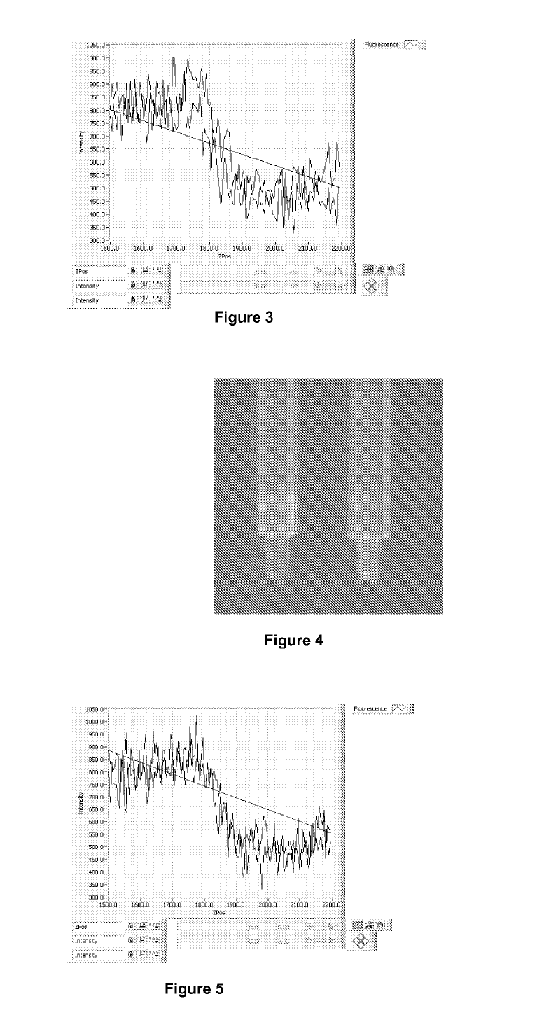

Measurement using a Toximet-T instrument showed a small decrease in the fluorescence of Polymer 1 after binding acenaphthylene (FIG. 3).

Quenching of fluorescence after binding acenaphthylene was also recorded using Gene Genius Bio Imaging System (Syngene Ltd., UK). This system consisted of darkroom cabinet and camera, UV transilluminator, Medalight LP400 panel and Gene Snap software. The set-up is typically used for recording the image of DNA fragments coloured with intercalating agent ethidium bromide (excitation wavelength of EtBr bound to DNA—302 nm).

The transillumination system also illustrated that binding acenaphthylene to Polymer 1 reduced polymer fluorescence (FIG. 4).

### Example 5

### Polymer 2: Adenosine Triphosphate (ATP) as Analyte

ATP is a negatively charged molecule.

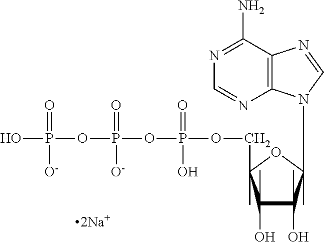

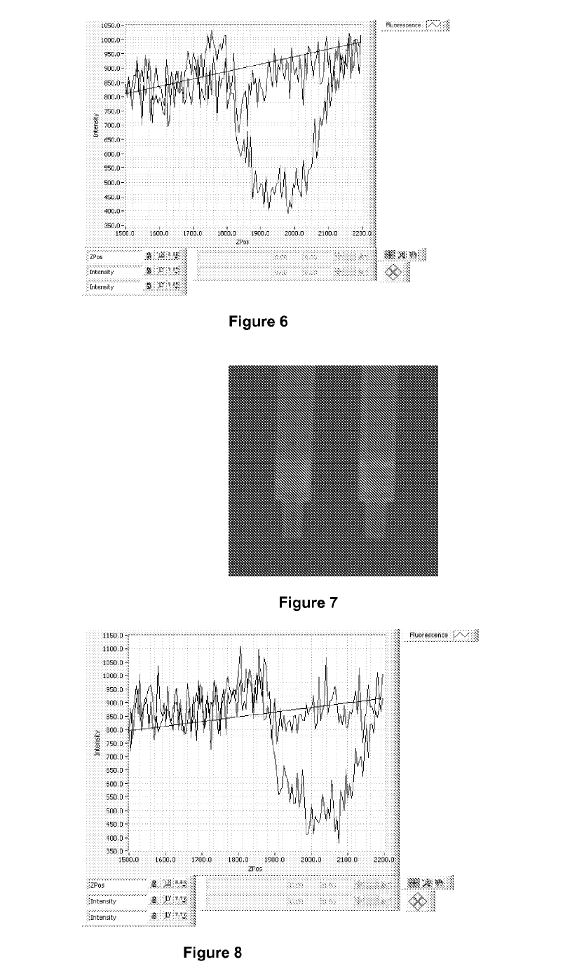

SPE tubes were packed with 75 mg of Polymer 2 (DEAEM). 1 ml of ATP in 5% methanol (2 mg/ml) was filtered through the cartridge. Some quenching of fluorescence was observed (FIG. 5).

### Example 6

### Polymer 3: Tylosin as Analyte

Immobilisation of an inorganic fluorescent indicator in a polymer is achievable by trapping the indicator in the polymer network during polymerisation (Examples 2-5). Alternatively, it is possible to create a fluorescent polymer using a polymerisable fluorescent compound, such as acenaphthylene. Acenaphthylene produces a strong fluorescent signal in the short UV range and possess a polymerisable double bond.

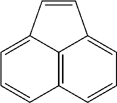

Two polymers (Polymer 3—negatively charged, containing itaconic acid as a functional monomer and Polymer 4—positively charged, containing DEAEM as a functional monomer) were prepared as described in Example 1.

SPE tubes were packed with 75 mg of Polymer 3 (itaconic acid, 0.5% acenaphthylene). 1 ml of tylosin tartrate in 5% methanol (3 mg/ml) was filtered through the cartridge. It was found that Polymer 3 possessed an affinity towards tylosin.

Binding was detected by means of fluorescence quenching (FIG. 6).

In the case of tylosin, the level of quenching of Polymer 3 fluorescence was significantly greater than that observed with Polymer 1 (Example 2, FIG. 1).

Following tylosin adsorption, the broad area of the fluorescent polymer seen under transillumination was darker (FIG. 7).

### Example 7

### Polymer 3: Chloramphenicol as Analyte

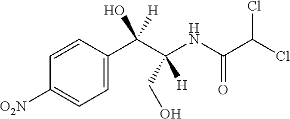

Polymer 3 was found to be capable of binding the antibiotic chloramphenicol. Polymer 3 was packed in an SPE cartridge and 1 ml of chloramphenicol solution in 5% methanol (3 mg/ml) was filtered through the cartridge. Measurement using a Toximet-T instrument suggested a 50% decrease in the fluorescent properties of Polymer 3 after binding (FIG. 8).

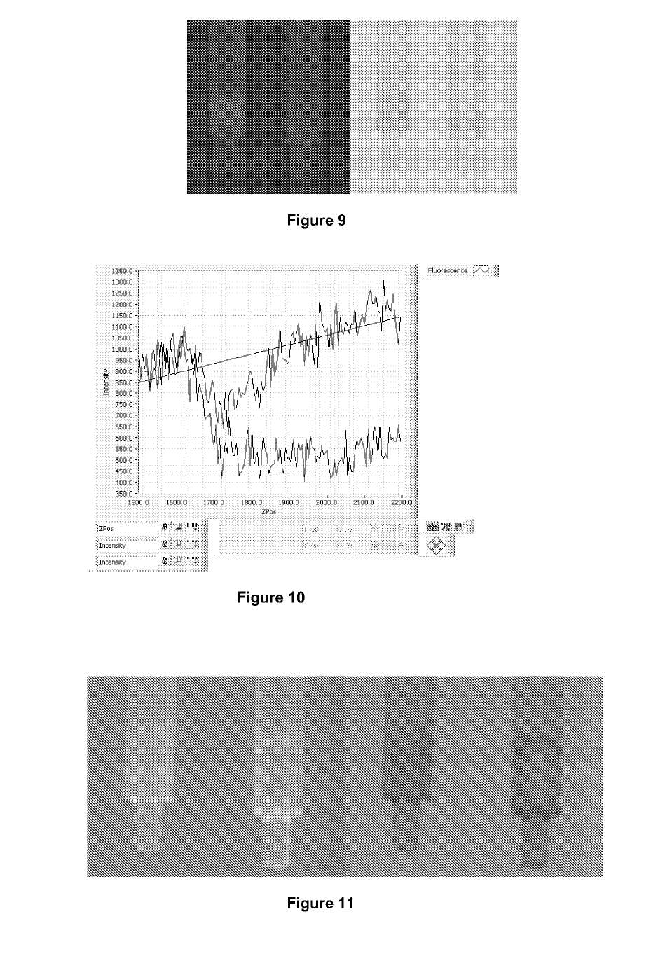

Transillumination of the chloramphenicol band of Polymer 3 also demonstrated the presence of fluorescence quenching (FIG. 9).

### Example 8

### Polymer 3: Sudan II as Analyte

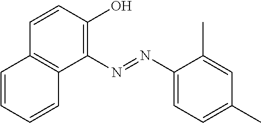

SPE tubes were packed with 75 mg of Polymer 3 (itaconic acid, 0.5% acenaphthylene). 1 ml of Sudan II in acetonitrile (0.5 mg/ml) was filtered through the cartridge. It was found that Polymer 3 adsorbed Sudan II and that adsorption resulted in significant fluorescence quenching (FIG. 10).

Transillumination depicted fluorescence quenching by Sudan II (FIG. 11).

### Example 9

### Polymer 3: Sudan III

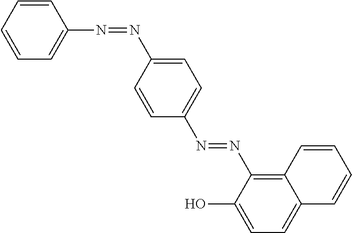

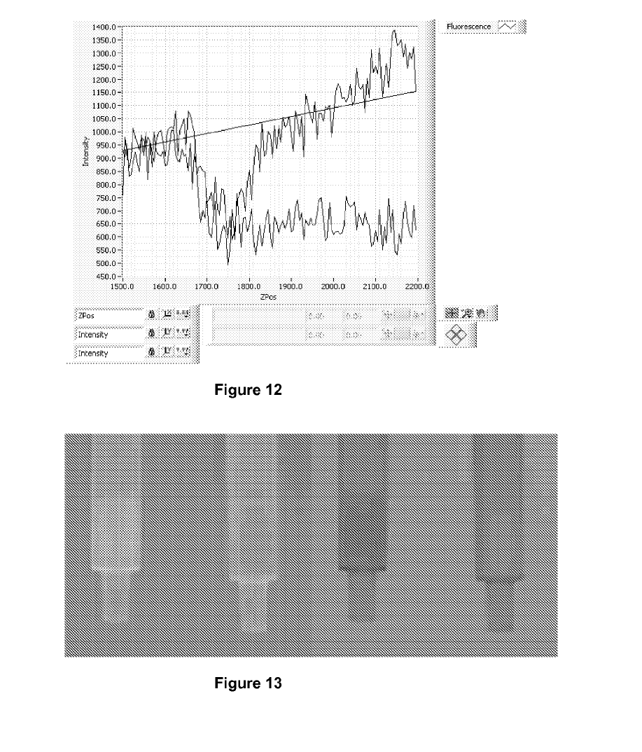

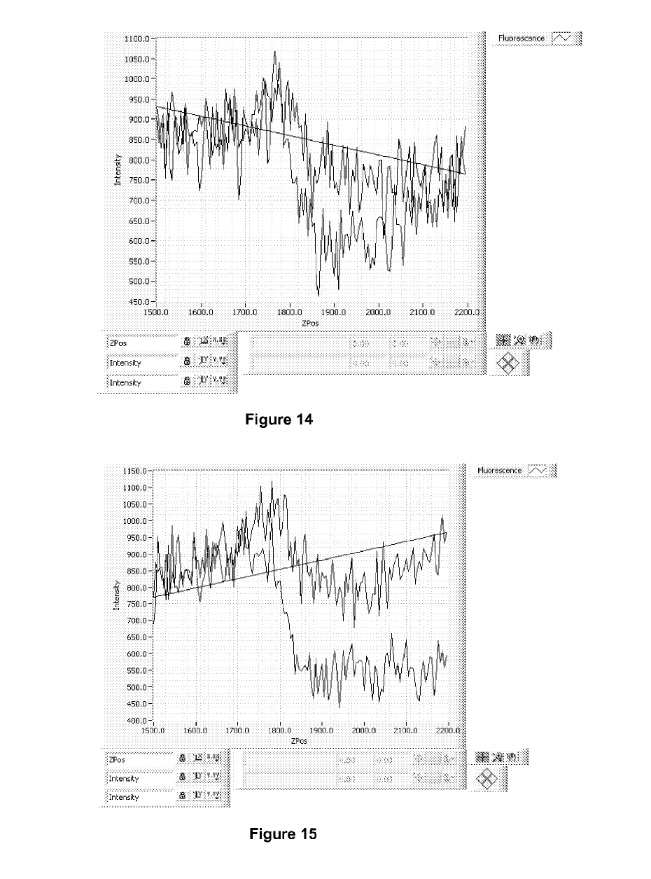

1 ml of Sudan III in acetonitrile (0.3 mg/ml) was filtered through a cartridge packed with 75 mg of Polymer 3. Binding of Sudan III was detected using fluorescence quenching with a Toximet-T instrument (FIG. 12) and transilluminator (FIG. 13).

### Example 10

### Polymer 4: ATP as Analyte

SPE tubes were packed with 75 mg of Polymer 4 (DEAEM, 0.5% acenaphthylene). 1 ml of ATP in 5% methanol (2 mg/ml) was filtered through the cartridge. In the case of ATP as analyte, it was found that Polymer 4 had better binding characteristics (FIG. 14) than Polymer 2 (FIG. 5).

### Example 11

### Polymer 4: N,N′-Diethyldithiocarbamic Acid Benzyl Ester (DCABE) as Analyte

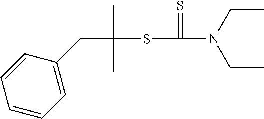

DCABE is a living polymerisation initiator or iniferter. It has high absorption in the short UV range.

SPE tubes were packed with 75 mg of Polymer 4 (DEAEM, 0.5% acenaphthylene). After conditioning the cartridge with 1 ml of methanol, 1 ml solution of DCABE in methanol (2 mg/ml) was filtered through the cartridge.

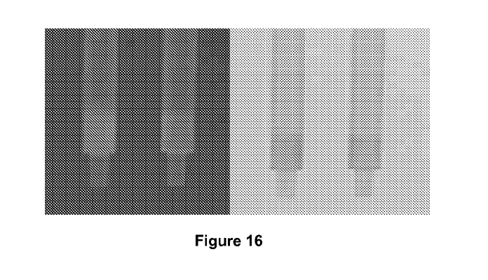

It was found that the fluorescence of Polymer 4 was quenched by adsorption of DCABE and that the quenching was detectable by a Toximet-T instrument (FIG. 15). Quenching was also illustrated using a transilluminator (FIG. 16).

1. An apparatus for detecting an analyte by fluorescence quenching, the apparatus comprising a solid phase extraction (SPE) carrier loaded with a polymer, the polymer having functional monomers for binding the analyte, wherein the polymer is fluorescent.

2. An apparatus as claimed in claim 1 wherein the fluorescent polymer comprises an inorganic fluorescent indicator.

3. An apparatus as claimed in claim 2 wherein the indicator is Fluorescent Indicator Green 254 nm.

4. An apparatus as claimed in claim 1 wherein the fluorescent polymer is produced using a polymerisable UV-adsorbent or fluorescent monomer, co-monomer or template.

5. An apparatus as claimed in claim 4 wherein the polymerisable monomer or co-monomer is acenaphthylene.

6. An apparatus as claimed in claim 1 wherein the SPE carrier is a cartridge, tube, cuvette, rod or flat surface.

7. An apparatus as claimed in claim 1 wherein the fluorescent polymer comprises itaconic acid or DEAEM as functional monomers.

8. An apparatus as claimed in claim 7 wherein the fluorescent polymer further comprises EGDMA as cross-linker and 1,1′-azobis(cyclohexanecarbonitrile) as initiator.

9. An apparatus as claimed in claim 1 suitable for adsorbing tylosin, chloramphenicol, Sudan II, Sudan III, ATP, acenaphthylene or DCABE.

10. An apparatus as claimed in claim 1 further comprising at least one of a fluorometer and a transilluminator.

11. A method of detecting the presence of an analyte in a sample comprising the steps of:
providing an SPE carrier loaded with a fluorescent polymer, the polymer having functional monomers for binding the analyte;
applying the analyte to the fluorescent polymer; and
detecting fluorescence quenching resulting from adsorption of the analyte onto the polymer.

12. The method of claim 11 wherein the analyte has high adsorption in the short UV range and minimal natural fluorescence.

13. The method of claim 11 wherein fluorescence quenching is detected using fluorometric apparatus.

14. The method of any one of claim 11 wherein fluorescence quenching is detected using a transillumination system.

15. The method of any one of claim 11 wherein the polymer comprises a fluorescent indicator or is produced using a polymerisable UV-adsorbent or fluorescent monomer, co-monomer or template.

16. The method of any one of claim 11 wherein the analyte is tylosin, chloramphenicol, Sudan II, Sudan III, ATP, acenaphthylene or DCABE, or other pharmaceuticals, proteins or toxins.

17. The method of any one of claim 11 wherein the polymer comprises itaconic acid or DEAEM as functional monomers.

18. The method of claim 17 wherein the polymer further comprises EGDMA as a cross-linker.

19. Use of a fluorescent polymer as an SPE adsorbent for quantifying analyte adsorption using fluorescence quenching.

20. Use according to claim 19 wherein the fluorescent polymer comprises an inorganic fluorescent indicator.

21-23. (canceled)
